(19) United States
(12) Patent Application Publication
(10) Pub. No.: US 2026/0298042 A1
(43) Pub. Date: Oct. 1, 2026

(54) Water management system

(71) Applicant: Hilti Aktiengesellschaft, Schaan (LI)

(72) Inventors: Helmut SPECHT, Irsee (DE); Philipp LORENZ, München (DE); Bernhard KUNZ, Schaan (LI); Gabor VIDA, Chur (CH); Goran GOLUBOVIC, Buchloe (DE); Claudiu Radu SANTEIU, Buchs (CH)

(21) Appl. No.: 19/577,640

(22) Filed: Mar. 25, 2026

(30) Foreign Application Priority Data
Apr. 1, 2025 (EP) 25167803.3

(51) Int. Cl. E21B 21/06

(52) U.S. Cl. CPC E21B 21/065

(57) ABSTRACT

A water management system for providing cooling water and treating drilling slurry produced during operation of a core drilling machine, the water management system including the following: a collection device for collecting drilling slurry or dust produced during operation of a core drilling machine, the collection device having an extraction body with a drilling opening which extends through the extraction body and is designed to receive a drill bit; a treatment device for treating drilling slurry, the treatment device being fluidically connectable to the collection device in such a way that drilling slurry or dust, which is collected by the collection device, can be conveyed to the treatment device; and a vacuum pump, which is fluidically connectable to the collection device, wherein the water management system is designed in such a way that the vacuum pump can be releasably fastened either, in a first arrangement, to the collection device or, in a second arrangement, to the treatment device.

This claims the benefit of European Patent Application EP 25167803.3, filed on Apr. 1, 2025 which is hereby incorporated by reference herein.

The present invention relates to a water management system for providing cooling water and treating drilling slurry, in particular but not exclusively during the operation of a core drilling system. Further aspects of the present invention relate to a vacuum pump and to a treatment device.

### BACKGROUND

In the field of core drilling machines, various devices are known for collecting drilling slurry produced during the execution of a core drilling operation. For example, water trap rings are known that can be attached to the substrate using mechanical fastening means, such as clips or clamping means. Other devices are attached to a substrate by means of a vacuum created by a suction device.

### SUMMARY OF THE INVENTION

However, the mechanical fastening means are associated with the disadvantage that they often cannot be removed from the substrate non-destructively, and therefore minor damage to the substrate cannot be ruled out.

When attaching the water trap rings with a vacuum, the problem is that the water trap ring can only be attached to the substrate and held there when a suction system of a water treatment device is switched on and is in operation. However, continuous operation of the suction system is not required for the execution of the core drilling operation, and suction devices consume a particularly large amount of electrical power, especially when idle. This disadvantage weighs even more heavily when battery-powered suction devices are used, which have only a limited amount of on-board power due to their supply of electrical power from batteries or the like. However, even if mains-powered water treatment devices are used, attaching conventional water trap rings by means of a suction device leads to unnecessarily high energy consumption. In addition, continuous operation of the water treatment device can lead to increased noise pollution on a construction site.

Furthermore, if the water trap ring can only be attached to the substrate while a suction device is in operation, it is a further disadvantage that the drilling site or construction site cannot be prepared for the core drilling to be carried out. However, this would be desirable for an efficient flow of work on a construction site. When using a suction device with automatic false air cleaning of a filter, there is the risk that the water trap ring will detach from the wall or the substrate due to the possibly reduced suction power of the suction device during filter cleaning.

In order to overcome these disadvantages, it is proposed in the prior art to spatially, i.e. fluidically, separate the extraction of drilling slurry and the vacuum required for fastening the collection device. Such solutions require a vacuum pump which generates a vacuum for attaching the collection device to the substrate. However, this means another auxiliary device, in addition to the treatment device, that has to be taken along by the user and calibrated. This also increases the space required on the construction site. Finally, the vacuum pump has to be placed in close proximity to the collection device in order to be able to produce a stable suction connection. However, this is particularly disadvantageous in places that are difficult to access.

It is an object of the present invention to provide a water management system in which a vacuum for attaching a collection device to the substrate can be generated in a simple and flexible manner. In particular, the intention is also to reduce the outlay on transport for using the water management system.

The present invention provides a water management system for providing cooling water and treating drilling slurry produced during operation of a core drilling machine, the water management system comprising the following:
a collection device for collecting drilling slurry or dust produced during operation of a core drilling machine, the collection device having an extraction body with a drill opening which extends through the extraction body and is designed to receive a drill bit;
a treatment device for treating drilling slurry, the treatment device being fluidically connectable to the collection device in such a way that drilling slurry or dust, which is collected by the collection device, can be conveyed to the treatment device; and
a vacuum pump, which is fluidically connectable to the collection device, wherein the water management system is designed in such a way that the vacuum pump can be releasably fastened either, in a first arrangement, to the collection device or, in a second arrangement, to the treatment device.

The water management system of the present invention has the advantage that the vacuum pump is arranged in a secure and space-saving manner at all times during the use of the system. Thus, the vacuum pump according to the present invention can be releasably fastened to the treatment device during the transport of the water management system. The user can thus transport and store the vacuum pump together with the treatment device. At the site of use, the vacuum pump can be removed from the treatment device and fastened to the collection device. The suction paths of the vacuum pump are therefore particularly small, since said vacuum pump is fitted directly to the collection device. By attachment of the vacuum pump to the collection device during use, it is particularly easy to operate the vacuum pump. In this way, the user, with just a few actions, can attach the collection device to the surface to be processed and, at the same time, activate the vacuum pump (e.g. by an appropriate switch on the vacuum pump). As soon as the vacuum pump is activated, air is sucked out of a vacuum chamber of the collection device in order to attach the collection device to the surface to be processed.

It is also conceivable, in principle, to use the vacuum pump also in its second arrangement on the treatment device. For example, the vacuum pump in this second arrangement can be fluidically connected via a suction hose to the collection device. This is particularly advantageous if an arrangement of the vacuum pump on the collection device seems to be unfavorable. For example, this may be the case if the collection device is supposed to be placed in narrow places, such as corner regions. In such use situations, there may often be no space for additionally fastening the vacuum pump to the collection device. In this case, the system of the present invention can be used in the second arrangement of the vacuum pump on the treatment device. The vacuum pump is then connected to the collection device via a suction hose in order to suck air out of the vacuum chambers of the collection device.

According to a further embodiment, the vacuum pump is fluidically connectable in the first arrangement and in the second arrangement to the collection device. Accordingly, the user is free to choose how the air should be sucked out of the vacuum chamber of the collection device. On the one hand, the vacuum pump can be connected directly to the collection device. On the other hand, the vacuum pump, in its second arrangement, can be connected to the collection device via a suction hose. The user can determine the arrangement of the vacuum pump individually, for example on the basis of space conditions or to simplify handling.

According to a further embodiment, the vacuum pump has a first suction connection, which is fluidically connected in the first arrangement of the vacuum pump to the collection device, and wherein the vacuum pump has a second suction connection, which is fluidically connected in the second arrangement of the vacuum pump to the collection device. The use of two suction connections can, on the one hand, ensure that, in the first arrangement of the vacuum pump, there is a secure fluidic connection between the suction connection and the vacuum chamber of the collection device. On the other hand, the second suction connection can be designed in such a way that it is freely accessible in both arrangements of the vacuum pump, i.e. at the collection device or at the treatment device. Thus, a corresponding suction hose can be connected to the second suction connection at any time in order to connect the vacuum pump to a collection device. By means of the two suction connections, it is in particular also conceivable for the vacuum pump, in its first arrangement on the collection device, to be able to be connected simultaneously to two or more collection devices.

According to a further embodiment, the vacuum pump has a first valve, which can be transferred between a closed and an open position, and wherein the first valve is designed in such a way that, when the vacuum pump is fastened to the collection device, the first valve is transferred from the closed state to the open state.

According to a further embodiment, the second suction connection is designed as a suction nozzle, wherein the second suction connection is connectable via a suction hose to a suction connection of the collection device.

According to a further embodiment, the vacuum pump has a second valve, which can be transferred between a closed and an open position, and wherein the second valve is designed in such a way that, when a suction hose is fastened to the second suction connection, the second valve is transferred from the closed state to the open state. The valves at the suction connections ensure that the vacuum pump only sucks up air via a suction connection when the connection is securely connected to the collection device. This prevents external air from being sucked up through one of the two suction connections if said suction connection is not connected to the collection device.

According to a further embodiment, the vacuum pump has a battery terminal for the releasable fastening of a battery. By means of the wireless design of the vacuum pump, the latter can be operated independently of the treatment device or the collection device. The vacuum pump can be supplied in particular with a comparatively small battery (e.g. small capacity), since maintaining the vacuum within the vacuum chambers of the collection device requires only occasional activity of the vacuum pump. At the same time, by providing the vacuum pump with a separate battery, it is ensured that said vacuum pump can be used directly in both arrangements and does not have to be connected to another energy supply device. Finally, according to this embodiment, the vacuum pump does not need to be connected to external power supplies, such as the battery of the treatment device. This is particularly advantageous if the treatment device itself is battery-operated. This increases the service life of the treatment device. Alternatively, however, it is also conceivable to design the vacuum pump in such a way that it has an interface that allows operation of the vacuum pump by means of the energy supply of the treatment device.

According to a further embodiment, the battery terminal is designed in such a way that a battery is releasably fastenable to the battery terminal in the first and the second arrangement. These embodiment variants make it possible for the battery to be changed in any arrangement of the vacuum pump, even during use. In particular, the vacuum pump does not need to be removed from its first or second arrangement in order to connect a battery to the battery terminal.

According to a further embodiment, the treatment device has a connection terminal, which is designed to connect the vacuum pump, in the second arrangement, electrically to the treatment device. The connection terminal of the treatment device may be used for data transfer between the treatment device and the vacuum pump. It is thus conceivable for the vacuum pump to be controlled via a control unit of the treatment device when said vacuum pump is arranged in its second arrangement on the treatment device. Data transmission can also be used to transmit usage or status data of the vacuum pump to the treatment device. The treatment device may be designed, for example, via an internal control unit, to evaluate said data or forward the data, for example to a cloud server for monitoring the vacuum pump. Alternatively or in addition, the connection terminal may be provided for power transmission between the treatment device and the vacuum pump. According to these embodiment variants, in the second arrangement of the vacuum pump, connection of a battery to the vacuum pump may be dispensed with. On the contrary, in the second arrangement, the vacuum pump is accordingly supplied with electrical energy by the power supply of the treatment device.

According to a further aspect, the present invention relates to a vacuum pump for generating a vacuum for collection devices for collecting drilling slurry or dust arising during operation of a core drilling machine, wherein the vacuum pump has fastening means which are designed to releasably fasten the vacuum pump either, in a first arrangement, to a collection device or, in a second arrangement, to a treatment device.

According to a further embodiment, the vacuum pump has a first suction connection, which, in the first arrangement of the vacuum pump, is fluidically connectable to a collection device.

According to a further embodiment, the vacuum pump has a second suction connection, which is designed as a suction nozzle in such a way that a suction hose is fluidically connectable to the second suction connection.

According to a further embodiment, the first suction connection is arranged on a first outer surface of the vacuum pump, wherein the second suction connection is arranged on a second outer surface of the vacuum pump, wherein the first outer surface is preferably substantially perpendicular to the second outer surface.

According to a further embodiment, the vacuum pump comprises the following:
a first valve, which can be transferred between a closed position, in which the first suction connection is closed, and an open position, in which the first suction connection is open;
a second valve, which can be transferred between a closed position, in which the second suction connection is closed, and an open position, in which the second suction connection is open.

Another aspect of the present invention relates to a treatment device for treating drilling slurry produced during operation of a core drilling machine, the treatment device having an interface for the releasable fastening of a vacuum pump.

### BRIEF DESCRIPTION OF THE DRAWINGS

Further advantages can be found in the following description of the figures. The figures, the description and the claims contain numerous features in combination. A person skilled in the art will expediently also consider the features individually and combine them to form further useful combinations.

In the figures:

FIG. 1 shows a schematic illustration of a core drilling system with a collection device;

FIG. 2 shows a perspective view from the front and from the rear of a vacuum pump according to an embodiment of the present invention;

FIG. 3A shows a cross section through the vacuum pump according to FIG. 2, along a first suction connection;

FIG. 3B shows a cross section through the vacuum pump according to FIG. 2, along a first suction connection;

FIG. 4 shows a perspective view of a treatment device with a vacuum pump according to FIG. 2;

FIG. 5 shows views of a collection device for connecting a vacuum pump according to FIG. 2 via the first suction connection; and

FIG. 6 shows a perspective view of a collection device for connecting a vacuum pump according to FIG. 2 via the second suction connection.

### DETAILED DESCRIPTION

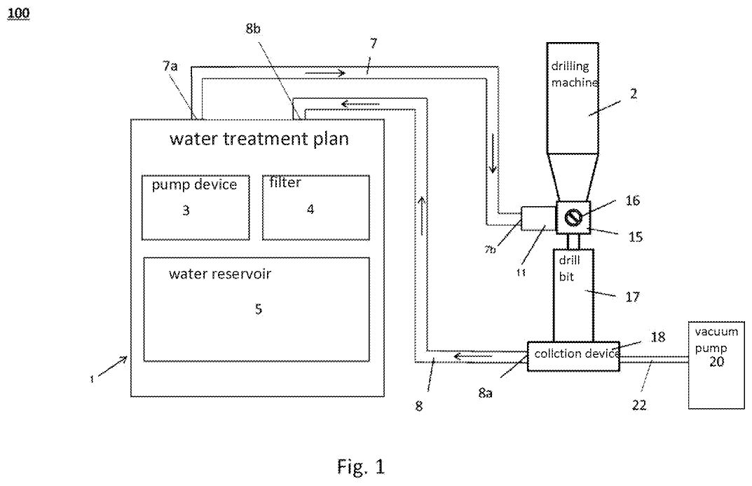

FIG. 1 shows a core drilling system 100. The core drilling system 100 has a treatment device 1, which is designed as a water treatment system and is connected to a power tool 2, which is designed as a core drilling machine. The core drilling machine 2 is connected to a tool 17, which is designed as a drill bit. The treatment device 1, which is designed as a water treatment system, is designed to provide cooling water to the tool and to extract and to clean used cooling water/drilling slurry.

The treatment device 1 essentially contains a housing, a water reservoir 5, a drilling slurry reservoir, a filter 4, a first line 7, a second line 8, a pump unit 3 and a control unit.

The housing is substantially in the form of a hollow body. In addition, an outer side of the housing contains an interface for supplying electrical voltage, e.g. a battery receptacle. Both the water reservoir 5 and the drilling slurry reservoir are positioned in the housing. The water reservoir 5 is used to store a supply of fresh water for cooling and flushing.

The drilling slurry reservoir is substantially in the form of a cylindrical container. The side walls and the bottom are designed as a filter 4 and are therefore made of a filter-like material, which is suitable for retaining the drilling slurry and only allowing water to penetrate. The drilling slurry reservoir and the water reservoir 5 are positioned in particular with respect to each other in such a way that the water emerging from the filter 4 of the drilling slurry reservoir is collected in the water reservoir 5.

The first line 7 (supply line) is in the form of a flexible hose and contains a first end 7a and a second end 7b. The first end 7a of the first line 7 is connected to the water reservoir 5. The second end 7b of the first line 7 is connected to a connecting piece 15 on the core drilling machine 2. The connecting piece 15 contains a valve 16 with which the flow through the first line 7 can be opened and closed. The open position of the valve 16 serves to allow water to pass through the first line 7 to the tool 17, which is in the form of a drill bit. The closed position of the valve 16 serves to ensure that no water can pass through the first line 7 to the drill bit 17.

The first line 7 serves to transport fresh water/filtered water from the water reservoir 4 to the drill bit 17. As shown in FIG. 1, the first line 7 is connected via the connecting piece 15 to the core drilling machine 2 in such a way that the water enters the interior of the drill bit 17. The water cools and flushes the drill bit 17 during a drilling operation. According to an alternative embodiment, it may also be provided that the first line 7 is first of all guided for cooling through the core drilling machine 2, before it finally reaches the drill bit 17 for cooling and flushing.

The second line 8 (return line) is also in the form of a flexible hose and contains a first end 8a and a second end 8b. The first end 8a of the second line 8 is connected to a collection device 18. The collection device 18 is positioned at the end of the drill bit 17 and is used to collect the drilling slurry (rocks, dust and water) arising during the drilling operation. The second end 8b of the second line 8 is connected to the drilling slurry reservoir in such a way that the drilling slurry can pass from the collection device 18 into the drilling slurry reservoir via the second line 8.

The pump device 3 contains a first pump section and a second pump section. The first pump section is connected to the first line 7 and is used to convey or to pump fresh water from the water reservoir 4 to the drill bit 17. The second pump section is connected to the second line 8 and is used to convey or to pump drilling slurry from the collection device 18 into the drilling slurry reservoir.

The collection device 18 may be arranged on the ground, on the one hand. In this case, the collection device does not need to be attached to the substrate. However, in the case of wall or ceiling bores, the collection device 18 has to be attached to the surface to be processed. Preferably, the collection device is designed in such a way that it can be attached by a vacuum to the surface to be processed. In other words, the collection device 18 may be firmly attached to the surface. For this purpose, the collection device 18 has a suction body, not shown in detail, which is designed to form a vacuum chamber together with the surface, in particular wall or ceiling surface. A vacuum pump 20 can be connected either directly or via a vacuum hose 22 to a suction body of the collection device 18 in order to apply a vacuum to the vacuum chamber.

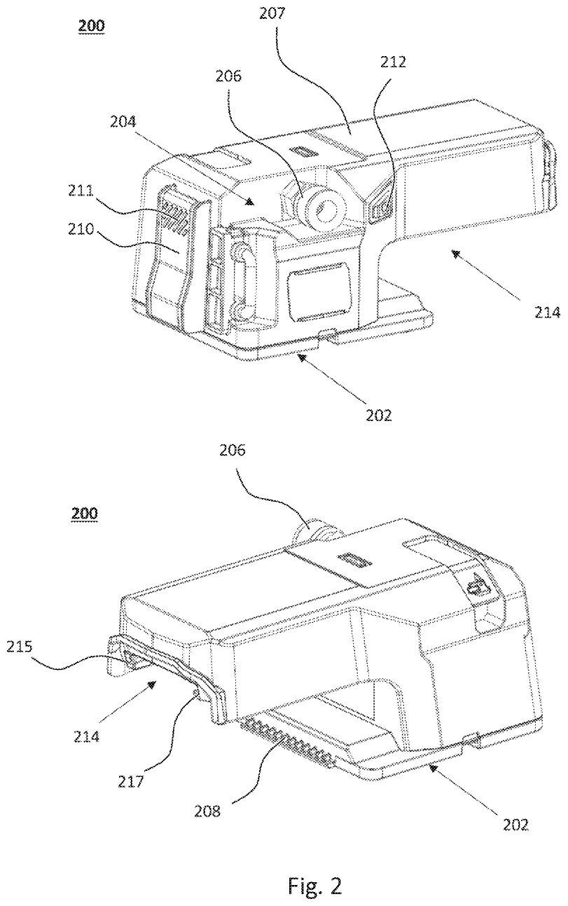

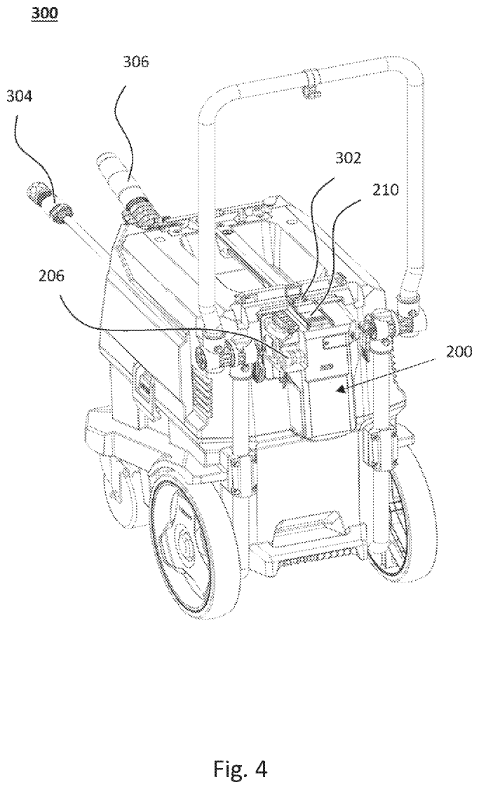

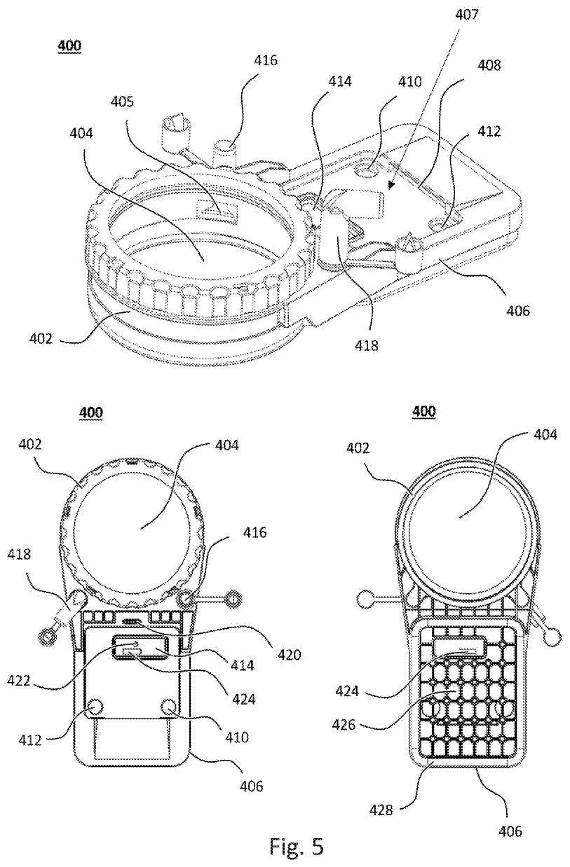

FIG. 2 shows perspective views from the front and rear of a vacuum pump according to an embodiment of the present invention. The vacuum pump 200 according to FIG. 2 can be mounted in a first arrangement on a collection device (for example, FIG. 5). In a second arrangement, the vacuum pump 200 can also be arranged on a treatment device (for example, FIG. 4).

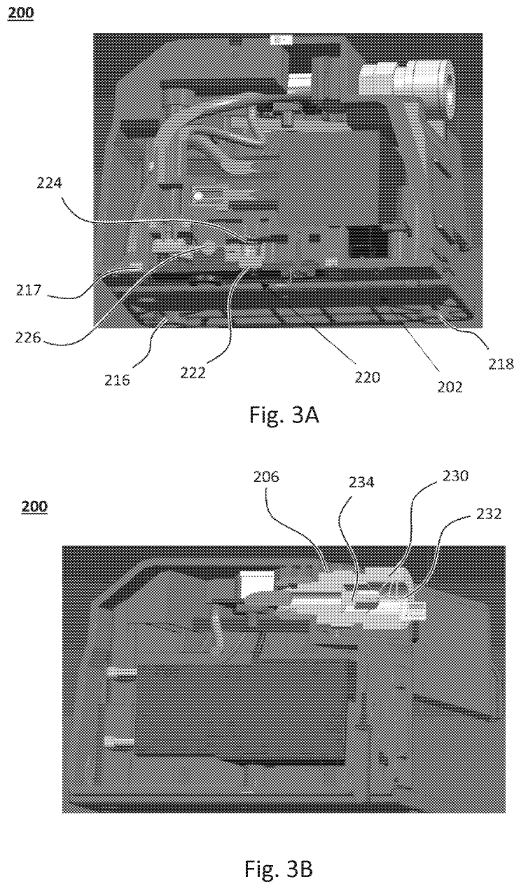

The vacuum pump 200 is designed in such a way that the suction function of the vacuum pump 200 changes depending on the arrangement. In the embodiment according to FIG. 2, the vacuum pump has two suction connections for this purpose. A first suction connection is arranged on a first outer surface 202 (underside) of the vacuum pump 200. A second suction connection 206 is arranged on a second outer surface 204 (side surface) of the vacuum pump 200. In this embodiment, the two suction connections therefore extend approximately perpendicular to each other. In other exemplary embodiments, the second suction connection may also be arranged on an outer surface 207 (upper side) opposite the first outer surface 202 (underside). As this will be explained in more detail with regard to FIGS. 3A and 3B, both suction connections can have a valve.

The vacuum pump 200 has fastening means 208, 210, in order to fasten the vacuum pump 200 releasably to a collection device or to a treatment device. A first fastening means 208 is arranged at a lower end of the vacuum pump 200. In other words, the first fastening means 208 is arranged on the first outer surface 202. The first fastening means 208 may be an extension, which can be inserted into a corresponding counterstructure of the collection device and/or of the treatment device.

A second fastening means 210 is in the form of a snap hook according to FIG. 2. The second fastening means 210, which is in the form of a hook, can be snapped into a corresponding counterstructure when fastening the vacuum pump 200 to the collection device or to the treatment device. To release the vacuum pump 200 from the collection device or the treatment device, the user can use a button 211 to release the snap hook from the corresponding counterstructure, for example from a clip.

The vacuum pump 200 is used in particular to attach collection devices to a surface to be processed. Accordingly, the vacuum pump 200 is used in particular to apply a vacuum to a vacuum chamber of the collection device connected to the vacuum pump 200. However, this is only necessary if the collection device is in use. Accordingly, the vacuum pump 200 has a switch 212 with which the operation of the pump 200 can be switched on and off.

Even during the use of the collection device, the vacuum pump 200 does not need to be operated continuously. Consequently, the vacuum pump 200 may have a control device or be connected to a control device of the collection device, the control device controlling the activity of the vacuum pump. For example, the operation of the vacuum pump 200 can be controlled on the basis of the vacuum in the vacuum chamber of the collection device. This allows the vacuum pump to be activated as soon as the vacuum exceeds a specified limit. This is especially useful when the vacuum pump 200 is battery-operated.

The embodiment of the vacuum pump 200 shown in FIG. 2 is a wireless vacuum pump, i.e. the vacuum pump 200 is battery-operated. Accordingly, the vacuum pump 200 has a battery terminal 214 for releasably fastening a battery to the vacuum pump 200. The battery terminal 214 is arranged in such a way that the battery can be inserted and removed while the vacuum pump 200 is connected via its first outer surface 202 to a collection device or a treatment device. For this purpose, the battery terminal has longitudinal guides 215, 217, which extend parallel to the first outer surface 202 (underside) of the vacuum pump 200.

FIG. 3A shows a sectional illustration of the vacuum pump 200 according to FIG. 2 along the first suction connection 220. As already mentioned above, the first suction connection 220 is arranged on the first outer surface 202 (underside) of the vacuum pump 200. The first suction connection 220 has a first valve 222. The first valve 222 is preloaded in its closed position, shown in FIG. 3A, via a return spring 224. Accordingly, the first suction connection 220 is in its closed state as long as the vacuum pump 200 is not connected to a collection device or treatment device. As this will be explained in more detail with regard to FIGS. 4 and 5, it is provided in the case of the vacuum pump 200 according to FIG. 3A that the first valve 222 is activated, i.e. opened, only when the vacuum pump 200 is connected via its first outer surface 202 to a collection device. Furthermore, according to this embodiment, the first valve 222 is intended to remain in its closed position when the vacuum pump 200 is connected to a treatment device.

When connecting the vacuum pump 200 to a corresponding collection device, a counterstructure (for example, pin) of the collection device can move the valve body of the first valve 222 counter to the return force of the return spring 224, in particular into the interior of the vacuum pump 200. In the embodiment shown in FIG. 3A, the valve body of the first valve 222 can move in particular about a pivot axis 226 into the cavity of the vacuum pump 200. By means of this movement, the first valve is transferred from its closed position shown in FIG. 3A into an open position, not shown. It follows that, in the open position of the first valve 222, air is sucked up via the first suction connection, i.e. at the first outer surface 202 (underside).

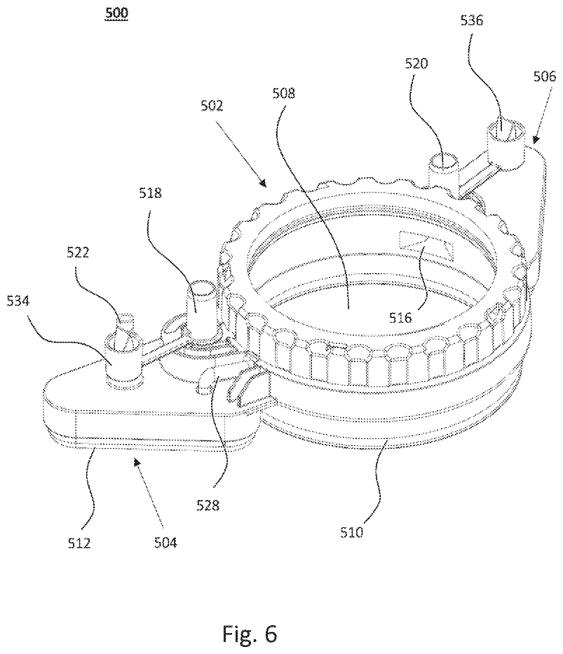

FIG. 3B shows a sectional illustration of the vacuum pump 200 according to FIG. 2 through the second suction connection 206. The second suction connection 206 is designed as a suction nozzle 230. It has a hose-receiving opening 232. The hose-receiving opening 232 is designed in such a way that a suction hose can be introduced into the hose-receiving opening 232. The suction hose is used in particular to connect the vacuum pump 200 to a corresponding suction nozzle of a collection device, as will be explained in more detail with regard to FIG. 6.

The second suction connection has a second valve 234, which can be transferred between a closed and an open position. The second valve 234 is also preloaded into its closed position. By a suction hose being fastened to the second suction connection 206, the second valve 234 is transferred from the closed state into an open state. In the closed state, no air can be sucked up via the second suction connection. Only after the suction hose is connected can air be sucked up via the second suction connection 206. It should be mentioned at this juncture that the vacuum pump 200 is designed in such a way that air can be sucked up either via only one of the two suction connections or via both suction connections simultaneously.

FIG. 4 shows an embodiment of a treatment device according to the present invention. The treatment device 300 is used for processing drilling slurry. Accordingly, the treatment device 300 is fluidically connectable to the collection device, in particular in such a way that drilling slurry or dust, which is collected by the collection device, can be conveyed to the treatment device 300. FIG. 4 schematically illustrates a cooling water supply line 304. The supply line 304 corresponds substantially to the line 7 discussed in FIG. 1 and serves to convey cooling water from the treatment device 300 to the drill bit of the core drilling machine.

In order to convey used cooling water, i.e. drilling slurry, from the collection device to the treatment device 300, the treatment device 300 has a return line 306. The return line 306 substantially corresponds to the line 8 mentioned in FIG. 1. The return line 306 is connected to a pump, not shown in FIG. 4, which serves to suck the drilling slurry out of the collection device and to suck it into the filter (not shown) of the treatment device 300.

The treatment device 300 has a fastening region on the outer side of the housing.

The fastening region is used to fasten the vacuum pump 200 to the treatment device 300. FIG. 4 schematically illustrates a first fastening means 302, which interacts with the second fastening means 210 of the vacuum pump, which second fastening means is in the form of a snap hook, in order to fasten the vacuum pump 200 stably and releasably to the treatment device 300. The treatment device 300 may also have a counterstructure, not shown, for the first fastening means, shown in FIG. 2, of the vacuum pump 200.

According to a preferred embodiment, the vacuum pump 200 is mounted on the treatment device 300 in such a way that the first suction connection 220, indicated in FIG. 3A, is not active, i.e. that the first valve 222 remains in its closed position. In other words, in the fastening region, the collection device 300 has no counterstructure (for example, pin) that could transfer the valve body of the first valve 222 to the open position.

The fastening region of the treatment device 300 is arranged in such a way that the second suction connection 206 of the vacuum pump 200 is freely accessible when the vacuum pump 200 is fastened to the fastening region, as shown in FIG. 4. It follows that, in the second arrangement, shown in FIG. 4, of the vacuum pump 200, i.e. in the arrangement of the vacuum pump 200 on the treatment device 300, only the second suction connection 206 can be used. As has already been mentioned with regard to FIG. 3B, the second suction connection 206 has a second valve 234, which is preloaded into its closed position. Accordingly, operation of the vacuum pump 200 in its second arrangement according to FIG. 4 is possible only if a suction hose is inserted into the suction hose connection 232 of the second suction connection 206 in order to open the second valve 234.

In the second arrangement, shown in FIG. 2, of the vacuum pump 200 on the treatment device 300, the vacuum pump 200 can be connected to a collection device via a suction hose. An exemplary embodiment of such a collection device is shown in FIG. 6. The vacuum pump 200 is accordingly operated in its second arrangement according to FIG. 3. The vacuum pump 200 therefore does not have to be removed from the treatment device 300 in order to apply a vacuum to a collection device.

The arrangement, shown in FIG. 3, of the vacuum pump 200 on the treatment device 300 has the advantage that the vacuum pump 200 can be transported directly together with the treatment device 300. The arrangement of the vacuum pump 200 on the treatment device 300 also saves space at the construction site.

In one embodiment of the present invention, the vacuum pump is battery-operated in both arrangements (first arrangement described further below). In other words, in both arrangements, the vacuum pump 200 has its own power supply. In particular, this is a battery, which can be releasably connected to the battery terminal 214. The vacuum pump is therefore not dependent on an external power supply. Since only little pumping power is required to suck the collection device onto the appropriate substrate, the vacuum pump 200 can also be equipped with a comparatively small battery. This is in particular in contrast to the necessary power of the treatment device 300, which requires a significantly higher amount of energy.

According to an alternative embodiment variant, the vacuum pump 200 can also be designed in such a way that the latter, in its second arrangement on the treatment device 300, draws energy via the treatment device 300. According to this embodiment, the fastening region of the treatment device has a connection terminal into which the vacuum pump 200 is inserted automatically when fastening the vacuum pump 200 to the treatment device 300. For example, the first fastening means 208 can be designed as a terminal to allow a conductive connection between the treatment device 300 and the vacuum pump 200. According to this embodiment, the vacuum pump 200 can be operated in the second arrangement via the battery of the treatment device 300.

FIG. 4 shows a perspective view, a top view and a view from below of a collection device according to an embodiment of the present invention. The collection device 400 has an extraction body 402. The extraction body 402 is annular. It has a drill opening 404, which extends through the extraction body 402 and is designed to receive a drill bit. The extraction body 402 is designed such that, when the drill bit is introduced into the drill opening 404, a cavity, in which the drilling slurry can be collected, extends around the drill bit. The extraction body 402 furthermore comprises one or more extraction openings 405. In the embodiment of the collection device 400 shown in FIG. 5, the extraction body 402 in particular has two extraction openings 405, of which only a first extraction opening 405 is shown. The extraction openings of the extraction body 402 are connected to extraction nozzles 416, 418. The extraction nozzles 416, 418 serve in particular for the connection of the return line 306 of the treatment device 300 according to FIG. 4.

The collection device 400 furthermore has a suction body 406. The suction body 406 is releasably or fixedly connected to the extraction body 402. In the embodiment according to FIG. 5, the suction body 406 is fixedly connected to the extraction body 402. The suction body 406 is used to attach the collection device 400 by means of a vacuum to the surface to be processed. According to the present invention, the suction body 406 has a fastening region 407. The fastening region 407 is used to fasten the vacuum pump 200 releasably to the collection device 400. The fastening region 407 has a first counterstructure 408, which is in the form of an undercut. The first counterstructure 408 serves to receive the first fastening means 208 of the vacuum pump 200. The fastening region 407 furthermore has recesses 410, 412, which interact with the projections 216, 218 (FIG. 3A) on the underside of the vacuum pump 200.

Finally, the suction body 406 has a suction region 414, which is connectable to the first suction connection 220 of the vacuum pump 200. In particular, the suction region 414 can be designed in such a way that it is sealed via a seal 217 (see, e.g., FIG. 2) of the vacuum pump when the vacuum pump 200 is fastened to the collection device 400. The suction region 414 has a suction opening 424. The suction opening 424 extends through the suction body 406 into the cavity 426 on the underside of the suction body 406, as shown in FIG. 5. The cavity 426 is a vacuum chamber of the collection device 400. The vacuum chamber 426 is sealed by the seal 428 with respect to the surface to be processed.

The collection device 400 has a second counterstructure 420, which can be designed, for example, as a clip. The second counterstructure 420 serves to interact with the second fastening means 210 of the vacuum pump. In particular, the second fastening means 210, which is in the form of a snap hook, of the vacuum pump can engage in the second counterstructure 420, which is in the form of a clip. In other words, for the fastening to the collection device 400, the vacuum pump is first inserted with its first fastening means 208 into the undercut 408 and then snapped onto the clip via the snap hook. To release the vacuum pump 200 from the collection device 400, the snap hook is first released and the vacuum pump 200 pivoted out of the recesses 410, 412 and the undercut 408.

The suction body 406 of the collection device 402 furthermore has a counterstructure 422 in the form of a pin. The counterstructure 422 in the form of a pin is used to transfer the second valve 222 from its closed position to its open position when the vacuum pump 200 is connected to the collection device 400. Accordingly, the vacuum pump 200 in its first arrangement on the collection device 400 serves to apply a vacuum to the vacuum chamber 426 via the first suction opening. In the embodiment shown here, the first suction connection of the vacuum pump is automatically fluidically connected to the suction opening 424 of the suction body 406 when the vacuum pump 200 is mounted on the fastening region 407 of the collection device 400.

In the first arrangement of the vacuum pump 200 on the collection device 400, firstly only the first suction connection 220 is opened. The second suction connection 206 remains closed until a suction hose is inserted. As will be described in more detail below, it is entirely conceivable for the vacuum pump 200, in particular in the first arrangement, to be simultaneously fluidically connected to two or more collection devices.

FIG. 6 shows a perspective view from above of another embodiment of a collection device 500 according to the present invention. The collection device 500 has an extraction body 502. In the embodiment shown here, the extraction body is in particular annular. A drill opening 508 extends through the extraction body 502. The drill opening 508 is designed to receive a drill bit of a core drilling machine. Accordingly, the diameter of the drill opening 508 is adapted to the diameter of the drill bit. In other words, the collection device can have extraction bodies with drill openings which differ in size and which are each tailored to the drill bit to be used.

In the embodiment shown here, the collection device 500 has two suction bodies 504, 506. The two suction bodies 504, 506 are connected to the extraction body 502. In particular, the two suction bodies 504, 506 are fixedly connected to the extraction body 502. The suction bodies 504, 506 cannot be moved relative to the extraction body 502.

According to the embodiment in FIG. 6, the suction bodies 504, 506 have a substantially identical shape. In particular, this is a triangular shape.

The extraction body 502 has a first seal 510. The first seal 510 of the extraction body 502 is arranged on an underside of the extraction body 502. It is used to produce a sealing connection to the surface to be processed (for example, wall or ceiling surface). Together with the surface to be processed, the extraction body 502 forms a cavity which extends around the drill opening 508. The cavity is sealed by the first seal 510 with respect to the surface to be processed in order to prevent the cooling water or drilling slurry from flowing out of the interior of the extraction body 502.

The first suction body 504 has a second seal 512. The second seal 512 serves to seal a cavity formed in the interior of the first suction body 504 with respect to the surface to be processed. Together with the surface to be processed, a first vacuum chamber is formed by the cavity. The first vacuum chamber is used to attach the collection device 500 via a vacuum to the surface to be processed.

The second suction body 504 has a third seal. The third seal serves to seal a cavity formed in the interior of the second suction body 506 with respect to the surface to be processed. Together with the surface to be processed, a second vacuum chamber is formed by the cavity. The second vacuum chamber is used to attach the collection device 500 via a vacuum to the surface to be processed.

The first suction body 504 has a vacuum connection 522. In the embodiment shown here, the vacuum connection 522 is arranged on a side of the first suction body 504 opposite the first seal 512. In other words, the vacuum connection 522 is arranged on the upper side of the first suction body 504.

The vacuum chamber of the first suction body 504 is connected to the vacuum chamber of the second suction body 506 via an air duct 528, indicated in FIG. 6. The vacuum chambers of the two suction bodies 504, 506 are fluidically separated from the cavity of the suction body 502. This is achieved in particular by the separate seals 510, 512, 514. A transfer of cooling water or drilling slurry or dust from the cavity of the extraction body 502 into the vacuum chamber of the suction bodies 504, 506 is therefore prevented. The suction bodies 504, 506 are used exclusively for holding the collection device 500 on the surface to be processed. On the other hand, the extraction body 502 is used exclusively to collect drilling slurry or dust arising during the drilling and to discharge it to a treatment device, already described above.

For attaching the collection device 500 to the surface to be processed (for example, wall or ceiling surface), a vacuum is generated within the vacuum chambers of the suction bodies 504, 506. To generate the vacuum, a first end of a suction hose (not shown) is fastened to the vacuum connection 522 of the first suction body 504. An opposite second end of the suction hose is connected to the second suction connection 206 of the vacuum pump. By means of the vacuum pump 200, a vacuum can thus be generated in the first vacuum chamber via the vacuum connection 522. As already mentioned above, the first vacuum chamber is connected to the second vacuum chamber of the second suction body 506 via an air duct. Part of the air duct 528 is shown in FIG. 6. Another part, not shown, of the air duct is preferably integrated at least in the extraction body 502.

Through the air duct between the vacuum chambers of the two suction bodies 504, 506, a vacuum can be achieved in both vacuum chambers using a single suction connection 522. The air in the vacuum chambers is thus conveyed via the suction connection 522 to the vacuum pump 200. For this purpose, the vacuum pump may be arranged on the treatment device (FIG. 4, “second arrangement”). Alternatively, the vacuum pump 200 may also be arranged on another collection device (e.g. collection device 400, FIG. 5, “first arrangement”).

For the extraction of the drilling slurry or dust from the cavity of the extraction body 502, at least one extraction opening 516 is provided in the cavity. In the embodiment shown in FIG. 6, two extraction openings are provided (only second extraction opening 516 shown). A first extraction opening extends through the inner wall of the cavity of the extraction body 502 in the direction of a first extraction channel. The second extraction opening 516 extends through the inner wall of the cavity in the direction of a second extraction channel. In FIG. 6, the extraction channels end in suction nozzles 518, 250. A first suction nozzle 518 is connected to a first extraction opening (not shown). A second suction nozzle 520 is connected to the second extraction opening 516.

The suction nozzles 518, 520 can be used to connect the return line 306 of the treatment device 300. Drilling slurry or dust can therefore be sucked out of the cavity via the two suction nozzles 518, 250 and conveyed to the treatment device.

During operation, the user can freely choose which of the two suction nozzles 518, 520 to connect to the treatment device, i.e. on which suction nozzle 518, 520 the suction hose is fitted. The other suction nozzle 518, 520 serves as a ventilation opening. This suction nozzle, which is used as a ventilation opening, is accordingly connected to a one-way valve 534 or 536 to prevent drilling slurry from flowing out of the ventilation opening.

As already indicated above, the vacuum pump 200 can, on the one hand, selectively extract air via either the first suction connection or the second suction connection. On the other hand, according to a further embodiment variant, it is also possible for the vacuum pump to extract air simultaneously via both suction connections 206, 220. For example, the vacuum pump can be arranged on a collection device 400 according to FIG. 5 and simultaneously connected via a suction hose to a second collection device 500 according to FIG. 6. According to this embodiment variant, the vacuum pump 200 can, on the one hand, draw air out of the vacuum chamber 426 of the first collection device 400 via the first suction connection 220. At the same time, the vacuum pump 200 can draw air out of the vacuum chambers of the second collection device 500 via the second suction connection 206 (and the suction hose). It is also conceivable for the vacuum pump 200 to be designed in such a way that it extracts air alternately from the vacuum chambers of the first and second collection devices 400, 500. For this purpose, the vacuum pump 200 may be equipped, for example, with a further control valve, which enables selective extraction via the first or second suction connection 206, 220.

The present invention is not limited to the combinations of features depicted in the embodiments, but results from a combination of all of the features disclosed herein.

What is claimed is:

1. A water management system for providing cooling water and treating drilling slurry produced during operation of a core drilling machine, the water management system comprising:
a collection device for collecting drilling slurry or dust produced during operation of a core drilling machine, the collection device having an extraction body with a drill opening extending through the extraction body and designed to receive a drill bit;
a treatment device for treating drilling slurry, the treatment device being fluidically connectable to the collection device in such a way that drilling slurry or dust collected by the collection device is conveyable to the treatment device; and
a vacuum pump fluidically connectable to the collection device, the water management system being designed in such a way that the vacuum pump is releasably fastenable either, in a first arrangement, to the collection device or, in a second arrangement, to the treatment device.

2. The water management system as recited in claim 1 wherein the vacuum pump is fluidically connectable in the first arrangement and in the second arrangement to the collection device.

3. The water management system as recited in claim 1 wherein the vacuum pump has a first suction connection fluidically connected in the first arrangement of the vacuum pump to the collection device, and wherein the vacuum pump has a second suction connection fluidically connected in the second arrangement of the vacuum pump to the collection device.

4. The water management system as recited in claim 3 wherein the vacuum pump has a first valve transferable between a closed and an open position, and wherein the first valve is designed in such a way that, when the vacuum pump is fastened to the collection device, the first valve is transferred from the closed state to the open state.

5. The water management system as recited in claim 3 wherein the second suction connection is designed as a suction nozzle, and wherein the second suction connection is connectable via a suction hose to a suction connection of the collection device.

6. The water management system as recited in claim 5 wherein the vacuum pump has a second valve transferable between a closed and an open position, and wherein the second valve is designed in such a way that, when a suction hose is fastened to the second suction connection, the second valve is transferred from the closed state to the open state.

7. The water management system as recited in claim 1 wherein the vacuum pump has a battery terminal for releasable fastening of a battery.

8. The water management system as recited in claim 7 wherein the battery terminal is designed in such a way that a battery is releasably fastenable to the battery terminal in the first and the second arrangement.

9. The water management system as recited in claim 7 wherein the treatment device has a connection terminal designed to connect the vacuum pump, in the second arrangement, electrically to the treatment device.

10. A vacuum pump for generating a vacuum for collection devices for collecting drilling slurry or dust arising during operation of a core drilling machine, the vacuum pump comprising:
at least one fastener designed to releasably fasten the vacuum pump either, in a first arrangement, to a collection device or, in a second arrangement, to a treatment device.

11. The vacuum pump as recited in claim 10 further comprising a first suction connection, the first suction connection, in the first arrangement of the vacuum pump, being fluidically connectable to the collection device.

12. The vacuum pump as recited in claim 11 further comprising a second suction connection designed as a suction nozzle in such a way that a suction hose is fluidically connectable to the second suction connection.

13. The vacuum pump as recited in claim 12 wherein the first suction connection is arranged on a first outer surface of the vacuum pump, wherein the second suction connection is arranged on a second outer surface of the vacuum pump.

14. The vacuum pump as recited in claim 13 wherein the first outer surface is perpendicular to the second outer surface.

15. The vacuum pump as recited in claim 12 further comprising:
a first valve transferable between a closed position where the first suction connection is closed, and an open position where the first suction connection is open;
a second valve transferable between a second closed position where the second suction connection is closed, and a second open position where the second suction connection is open.

16. A treatment device for treating drilling slurry produced during operation of a core drilling machine, the treatment device comprising an interface for the releasable fastening of a vacuum pump.
